(19) United States
(12) Patent Application Publication
(10) Pub. No.: US 2025/0308757 A1
(43) Pub. Date: Oct. 2, 2025

(54) COIL COMPONENT

(71) Applicant: TAIYO YUDEN CO., LTD., Tokyo (JP)

(72) Inventor: Hirotaka WAKABAYASHI, Tokyo (JP)

(21) Appl. No.: 19/092,402

(22) Filed: Mar. 27, 2025

(30) Foreign Application Priority Data
Mar. 29, 2024 (JP) 2024-055508
Mar. 10, 2025 (JP) 2025-37278

(51) Int. Cl. H01F 27/29; H01F 27/24

(52) U.S. Cl. CPC H01F 27/292; H01F 27/24

(57) ABSTRACT

A coil component includes a magnetic base body, and a conductor provided in the magnetic base body or on a surface of the magnetic base body. The coil component also includes an external electrode provided on the surface of the magnetic base body. The external electrode includes a base electrode that has a joint portion joined to an end of the conductor. The joint portion extends in the same range as the end of the conductor. An area ratio of (111) crystal planes in the joint portion is smaller than an area ratio of other crystal planes in the joint portion.

### CROSS REFERENCE TO RELATED APPLICATIONS/INCORPORATION BY REFERENCE

This application makes reference to, claims priorities to, and claims benefits from Japanese Patent Application No. JP 2024-055508, filed on Mar. 29, 2024 and Japanese Patent No. 2025-37278, filed on Mar. 10, 2025.

### FIELD OF THE DISCLOSURE

This disclosure relates to coil components.

### DESCRIPTION OF THE RELATED ART

The number of electronic components used in an electronic product increases due to environmental changes such as an increase in the electrification of a vehicle, and applications in which electronic components are used are also expanding. This situation is common to many electronic components, and the same applies to a wire-winding-type coil component that has a conductor (wires) wound around a magnetic main body. However, the wire-winding-type coil components have limitations such as assembly accuracy and therefore downsizing of the wire-winding-type coil components has not been achieved as much as other types of electronic components. There is a demand for downsizing the wire-winding-type coil component, and use of thinner conductive wire is also desired.

Electronic components are often mounted on a mounting board by solder. As the downsizing of electronic components proceeds, the components and the solder tend to be damaged by a stress caused by deflection and temperature change of the mounting board. For this reason, countermeasures against stress are required for coil components.

For example, JP 2019-041075A discloses a coil component in which the adhesion strength of the bottom electrode to the component body is lower than the adhesion strength of the end electrode to the component body. When an external force is applied to the external electrode, the bottom electrode, which is a part of the external electrode, moves relative to the component body to disperse the stress.

### SUMMARY OF THE DISCLOSURE

If the configuration of JP 2019-041075A is used, a part of the external electrode is caused to move by stress. As a part of the external electrode moves, the conductor (wires) is subjected to stress of elongation and contraction. In particular, if a coil component has a thin conductor (thin wire), the movement of the external electrode increases the load applied to the conductor. Because the end of the conductor is joined to the external electrode, the connection between the conductor and the external electrode may be damaged by a load if a large load is applied to the conductor. Therefore, enhanced connection between the external electrode and the conductor is required. Enhanced connection is also required between the external electrode and the conductor in the coil component of the laminated type if the downsizing of the coil component is required.

An object of the present disclosure is to improve connection between an external electrode and a conductor.

Additional or separate features and advantages of the disclosure will be set forth in the descriptions that follow and in part will be apparent from the description, or may be learned by practice of the disclosure. The objectives and other advantages of the disclosure will be realized and attained by the structure particularly pointed out in the written description and claims thereof as well as the appended drawings.

To achieve these and other advantages and in accordance with the objective of the present disclosure, as embodied and broadly described, in one aspect, the present disclosure provides a coil component that includes a magnetic base body (element body), and a conductor provided in the magnetic base body or on a surface of the magnetic base body. The coil component also includes an external electrode provided on the surface of the magnetic base body. The external electrode includes a base electrode that has a joint portion joined to an end of the conductor. The joint portion extends in (over) the same range as the end of the conductor. An area ratio of (111) crystal planes in the join portion is smaller than a total area ratio of other crystal planes in the joint portion.

The joint portion may be sandwiched between the surface of the magnetic base body and the end of the conductor.

The base electrode may have a first base electrode around the joint portion. An area ratio of (111) crystal planes in the first base electrode may be smaller than a total area ratio of other crystal planes in the first base electrode.

The base electrode may have a second base electrode around the first base electrode. An area ratio of (111) crystal planes in the second base electrode may be greater than a total area ratio of other crystal planes in the second base electrode.

The external electrode may include a conductive resin layer outside the joint portion. The conductive resin layer may contain metal particles and a resin.

The conductive resin layer may extend in a range wider than a range of the joint portion.

The conductive resin layer may cover (extend over) the end of the conductor.

The external electrode may have a plating layer on a surface thereof.

According to the present disclosure, the joint between the external electrode and the conductor is enhanced.

### BRIEF DESCRIPTION OF THE DRAWINGS

FIG. 1 is a diagram that illustrates a perspective view of a coil component according to an embodiment of the present disclosure.

FIG. 2 is a diagram that illustrates a cross-sectional view taken along the II-II line in FIG. 1.

FIG. 3 is a diagram that illustrates a cross-sectional view taken along the III-III line in FIG. 2.

FIG. 4A is a diagram that illustrates the microscopic structure of the joint surface of the joint portion.

FIG. 4B is a schematic diagram useful to describe a structure of the joint portion prior to joining.

FIG. 4C is a schematic diagram useful to describe a structure of the joint portion after the joining.

FIG. 5 is a diagram that illustrates a longitudinal sectional view showing a first modification in which the orientation of the drum core is different from FIG. 2.

FIG. 6 is a diagram that illustrates a cross-sectional view taken along the VI-VI line in FIG. 5.

FIG. 7 is a diagram that illustrates a longitudinal section showing a second modification (lamination type).

FIG. 8 is a diagram that illustrates a cross-sectional view taken along the VIII-VIII line in FIG. 7.

FIG. 9 is a diagram that illustrates a first example of an E-core type magnetic base body.

FIG. 10 is a diagram that illustrates a second example of the E-core type magnetic base body.

FIG. 11 is a diagram that illustrates a first modification to the structure of the external electrode.

FIG. 12 is a diagram that illustrates a second modification to the structure of the external electrode.

FIG. 13 is a diagram that illustrates a modification to the join portion (narrow joint portion).

### DETAILED DESCRIPTION OF EMBODIMENTS

The following is a detailed description of embodiments of the disclosure with reference to the accompanying drawings. The following embodiments are not intended to limit the disclosure, and not all of the combinations of features described in the embodiments are essential for the configuration of the disclosure. The configuration of the embodiments may be modified or changed if necessary, depending on the specifications of the device to which the disclosure is applied and various conditions (conditions of use, environment of use, etc.).

The technical scope of the disclosure is defined by the claims and is not limited by the following individual embodiments. The drawings used in the following description may differ in scale and shape from the actual structure in order to make each configuration easier to understand. Parts, elements, and components shown in one of the drawings may be referred to in the description of other drawings.

### One Embodiment of a Coil Component

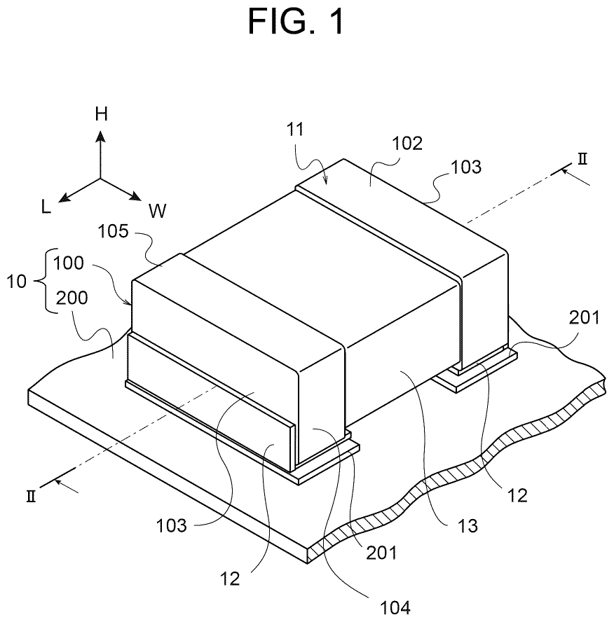

FIG. 1 is a perspective view of a coil component 100 according to an embodiment of the present disclosure.

The coil component 100 is mounted on a substrate (board) 200. The substrate 200 may be referred to as a mounting board. The substrate 200 is provided with two land portions 201. The coil component 100 has two external electrodes 12. The coil component 100 is mounted on the substrate 200 by joining the two external electrodes 12 to the two land portions 201, respectively, with solder.

Reference numeral 10 denotes a circuit device (circuit board) that includes the coil component 100 and the board 200 on which the coil component 100 is mounted. The circuit device 10 is used in various electronic devices. The electronic device including the circuit device 10 is, for example, an electric component of an automobile, a server, a board computer, or other electronic devices.

The coil component 100 may be an inductor, a transformer, a filter, a reactor, or various other coil components. The coil component 100 may be a coupled inductor, a choke coil, or various other magnetically coupled coil components. The coil component 100 may be, for example, an inductor used in DC/DC converters. The applications of the coil component 100 are not limited to those specified in this specification.

In this specification, unless the context otherwise requires, the description of the direction is based on the L-axis direction, W-axis direction, and H-axis direction of FIG. 1. The L-axis direction is a length direction. The W-axis direction is a width direction. The H-axis direction is the height direction.

The coil component 100 has, for example, a rectangular parallelepiped shape. The coil component 100 has outer surfaces (right and left surfaces) at opposite ends in the length direction L, outer surfaces (top and bottom surfaces) at opposite ends in the height direction H, and outer surfaces (front and back surfaces) at opposite ends in the width direction W. The rectangular parallelepiped shape of the coil component 100 has eight corners and twelve ridges.

The dimensions of the sides of the rectangular parallelepiped-shaped coil component 100 are such that the dimension in the length direction L is, for example, in the range of 1.0 mm to 4.5 mm, the dimension in the width direction W is, for example, in the range of 0.5 mm to 3.2 mm, and the dimension in the height direction H is, for example, in the range of 0.5 mm to 1.0 mm. The dimension of the coil component 100 in the height direction H is smaller than the dimension in the length direction L. The dimension of the coil component 100 in the height direction H is smaller than the dimension in the width direction W.

Each of the outer surfaces of the coil component 100 may be a flat plane, a curved surface, or a surface having a step (convex/concave) in a part thereof. The eight corners and the twelve ridges of the coil component 100 may be rounded.

In this specification, even when a part of the outer surface of the coil component 100 is curved or has a step, or when a corner portion or a ridge portion of the coil component 100 has a rounded shape, the coil component 100 having such a shape may be referred to as a rectangular parallelepiped shape component. In other words, in this specification, the term “rectangular parallelepiped” or “rectangular parallelepiped shape” does not mean “rectangular parallelepiped” in a mathematically strict sense.

### Structure of the Coil Component

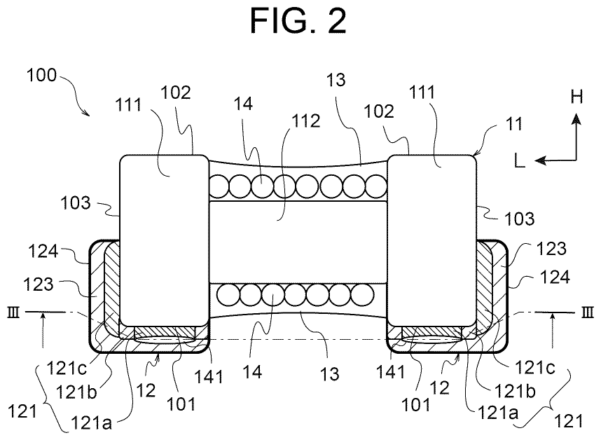

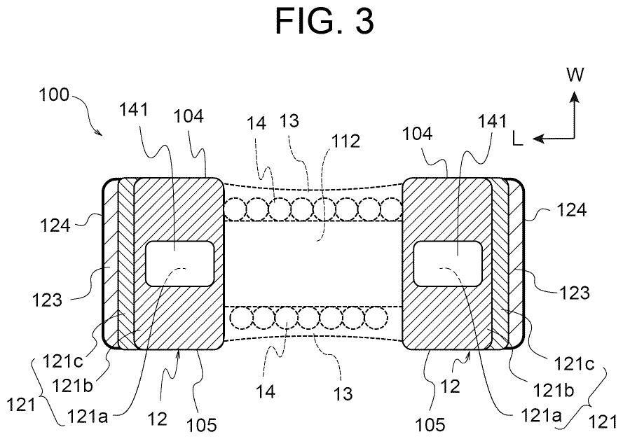

FIG. 2 is a cross-sectional view taken along the II-II line in FIG. 1. FIG. 3 is a cross-sectional view taken along the III-III line in FIG. 2. Hereinafter, the coil component 100 will be described with reference to FIGS. 1 to 3.

The coil component 100 includes, for example, a magnetic base body (element body) 11, external electrodes 12, and a conductor 14 inside the magnetic base body 11. The coil component may also include an exterior portion 13.

The magnetic base body 11 is called a drum core, and includes two flanges 111 and a winding core 112. The magnetic base body 11 has side surfaces (left and right surfaces) 103 at both ends in the length direction L. The magnetic base body 11 has a bottom surface 101 at one end in the height direction H of the flange 111, and has an upper surface 102 at the other end in the height direction H. The magnetic base body 11 has a front surface 104 at one end in the width direction W of the flange 111, and a rear surface 105 at the other end in the width direction W. The bottom surface 101 is a mounting surface that will face the substrate 200 when the coil component 100 is mounted on the substrate 200.

The upper surface 102 is a surface opposite to the bottom surface 101, i.e., the upper surface 102 faces upward and the bottom surface 101 faces downward. The upper surface 102 is adjacent to the side surfaces 103, the front surface 104, and the rear surface 105. Similarly, the bottom surface 101 is adjacent to the side surfaces 103, the front surface 104, and the rear surface 105. If two surfaces are adjacent to each other, these two surfaces are in a positional relationship in which other surfaces are not interposed between the two adjacent surfaces. One ridge is defined by each two adjacent surfaces. In the illustrated embodiment, the adjacent surfaces are orthogonal to each other. The upper surface 102 may be referred to as the top surface 102.

The magnetic base body 11 includes a magnetic material, and may also include a non-magnetic material. The magnetic material for the magnetic base body 11 may be ferrite and a soft magnetic metal. The nonmagnetic material for the magnetic base body 11 may be alumina or glass. It should be noted that the magnetic material for the magnetic base body 11 may be a variety of crystalline or amorphous metal magnetic materials or a combination of crystalline and amorphous materials.

The crystalline metal magnetic material that can be used as the magnetic material for the magnetic base body 11 is, for example, a crystalline metal material containing Fe as a main component in an amount of 50 wt % or more, or 85 wt % or more, and containing one or more elements selected from the group consisting of Si, Al, Cr, Ni, Ti, and Zr. The amorphous metal magnetic material that can be used as the magnetic material for the magnetic base body 11 is, for example, an amorphous metal material containing either B or C in addition to any of Si, Al, Cr, Ni, Ti, Zr.

The magnetic material for the magnetic base body 11 may be pure iron made of Fe and inevitable impurities. Alternatively, the magnetic material for the magnetic base body 11 may be a material obtained by combining pure iron made of Fe and inevitable impurities with a metallic magnetic material which is a certain kind of crystalline or amorphous alloy. The material of the magnetic base body 11 is not limited to those explicitly described in this specification, i.e., the material of the magnetic base body 11 may be any suitable material known as the material of the base body of the coil component.

The magnetic base body 11 may be made by the following method. Firstly, a powder of the above-mentioned magnetic material or non-magnetic material is mixed with a lubricant to prepare a mixed material. Then, the mixed material is loaded into a cavity of the mold and is subjected to press molding thereby making a green compact. Subsequently, the green compact undergoes heat treatment to make the magnetic base body 11. The green compact may be shaped by being subjected to grinding before the heat treatment. The magnetic base body 11 may be molded by a molding method.

Alternatively, the magnetic base body 11 may be manufactured by mixing a powder of the above-described magnetic material or non-magnetic material with a resin, a glass, or an insulating oxide (e.g., Ni—Zn ferrite or silica), shaping the mixed material by a lamination method or the like, and heat-treating the mixed material. The heat treatment applied to the magnetic base body 11 may be decided depending upon the raw material used. For example, the heat treatment may include thermal curing at a temperature of 200 degrees C. or less, or sintering at a temperature of 600 degrees C. or higher (or 1100 degrees C. or higher).

The magnetic base body 11 is preferably not affected by heat at the time of forming the external electrodes 12. Specifically, it is preferable that an amount of the resin or the like contained in the magnetic base body 11 be small because the resin or the like is affected by heat at the time of forming the external electrodes. It is desirable that the ratio of the resin is less than, for example, 1% of the volume of the magnetic base body 11.

The conductor 14 is formed by winding a metal wire around the core 112 of the magnetic base body 11. The metal conductor has an insulating film on its surface. The main body of the conductor 14 is a wire-winding portion that has the conductive wire wound around the core 112. The conductive wire of the conductor 14 is made of a metal material having excellent conductivity. The metal material for the conductors 14 is, for example, one or more metals of Cu, Ag and Al, or an alloy of these metals. The conductor 14 has a low resistance. Specifically, the filling ratio of the metal material in the conductor 14 is, for example, 90% or more (or 98% or more). The insulating material used as the coating film of the conductor 14 may be a general material such as polyamide-imide, polyamide, polyimide, or polyurethane.

The cross-sectional shape of the conductive wire of the conductor 14 is, for example, circular, rectangular or oval. It is desirable to use a general-purpose conductive wire as a conductive wire of the conductor 14 for reasons such as low resistance and dealing with diversification (dealing with different applications). The number of turns of the wire in the wire-winding portion of the conductor 14 is, for example, between 1.5 turns and 10.5 turns. The overall shape of the winding wire may be a planar shape or a spiral shape. It should be noted that the wire winding portion may have two groups of wire-winding that face each other to form, in combination, a single aggregate. FIG. 2 and FIG. 3 show a so-called vertical wire-winding in which the conductive wire revolves generally in parallel to the side surfaces 103 of the magnetic base body 11.

The conductor 14 has lead-out portions (ends 141 of the lead-out portions are only shown in FIG. 2) for electrical conduction with the outside. The ends 141 of the lead-out portions are connected to base electrodes 121 (to be described later) of the external electrodes 12, respectively. The external electrodes 12 are electrically connected to the conductor 14 as the ends 141 of the conductor 14 are joined to the base electrodes 121.

The joining between each of the base electrodes 121 and the associated end 141 of the conductor 14 is achieved by, for example, placing the end 141 on the base electrode 121, and applying heat to the base electrode 121 and the end 141. At least a portion of the base electrode 121 and a portion of the associated end 141 are melted by the applied heat, so that the two metals (the base electrode 121 and the end 141) are joined to each other.

Heating in the above-mentioned joining process is performed at a temperature lower than the temperature at which the two metals (the base electrode 121 and the end 141) are completely melted, or the heating time is limited to a time shorter than the complete melting. The joining process is performed at a temperature lower than a sintering temperature of the base electrodes 121. The sintering temperature will be described later. If the heating time is limited, the heating temperature may be a temperature close to the complete melting temperature. For example, the heating temperature (joining temperature) of the conductor 14 and the base electrode 121 is between 0.5 times and 0.8 times the metal melting point of the conductor 14 when measured in Kelvin temperature.

The heating process in the above-mentioned joining process includes, for example, laser irradiation to the end 141 of the conductor 14 or pressure heating with a heater chip. Lasers are used in the heating process when the cross-sectional area of the wire of the conductor 14 is greater than 0.008 mm². On the other hand, the heater chip is used for the conductor 14 if the cross-sectional area of the wire of conductor 14 is equal to or smaller than 0.008 mm². The selection of the heating processes is also influenced by the thermal conduction at the time of joining. Specifically, lasers are used when the volume of the coil component 100 is larger than 50 mm³, and heater chips are used when the volume of the coil component 100 is smaller than or equal to 50 mm³.

The exterior portion 13 is made of a resin material containing ceramic particles and metal particles, and surrounds the outer periphery of the wire-winding portion of the conductor 14 to protect the conductor 14. The exterior portion 13 is formed, for example, by applying a paste of a resin material to the outer periphery of the wire-winding portion of the conductor 14.

The coil component 100 includes, for example, the two external electrodes 12. The external electrodes 12 shown in FIGS. 1 to 3 may be referred to as two-sided electrodes because each of the external electrodes 12 is formed on the two surfaces (i.e., the bottom surface 101 and the side surface 103) of the magnetic base body 11. It should be noted that each of the external electrodes 12 may only be formed on the bottom surface 101, and such external electrodes 12 are referred to as a one-sided electrode.

It should be noted that the term “provided on a surface” or “formed on a surface” means being provided/formed at a position (or in an area) visible when the surface is viewed. An object (or an item) may extend outward from the surface when viewed in a direction perpendicular to the surface or may extend downward in the direction perpendicular to the surface.

### Structure of the External Electrode

Each of the external electrodes 12 includes, for example, the base electrode 121, a conductive resin layer 123, and a plating layer 124. The base electrode 121 includes, for example, a joint portion 121a to which the end 141 of the lead-out portion of the conductor 14 is joined, a first base electrode 121b around the joint portion 121a, and a second base electrode 121c. It should be noted that the base electrode 121 may not have the second base electrode 121c. When the external electrode 12 includes the conductive resin layer 123, the conductive resin layer 123 is provided outside the base electrode 121. When the external electrode 12 includes the plating layer 124, the plating layer 124 is provided outside the base electrode 121 and the conductive resin layer 123.

Each of the base electrodes 121 is made of any one of Cu, Ag and Pd, and is sintered. Alternatively, the base electrode 121 may be made of an alloy containing any of Cu, Ag and Pd, and may also contain a glass-material. The joint portion 121a is an area sandwiched between the outer surface of the magnetic base body 11 and the end 141 of the conductor 14. When the crystal planes in the joint portion 121a are divided into (111) crystal planes and other crystal planes, the joint portion 121a includes “other crystal planes” in addition to the (111) crystal planes. In the joint portion 121a, when the presence of the (111) crystal planes is compared with the presence of the “other crystal planes” in terms of area ratio, the area ratio of the “other crystal planes” (crystal planes other than the (111) crystal planes) is larger than the area ratio of the (111) crystal planes.

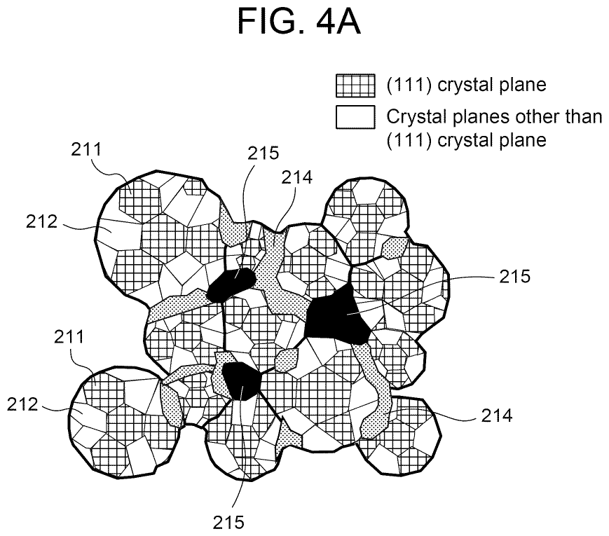

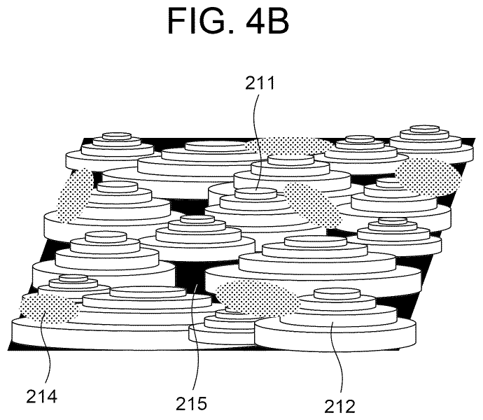

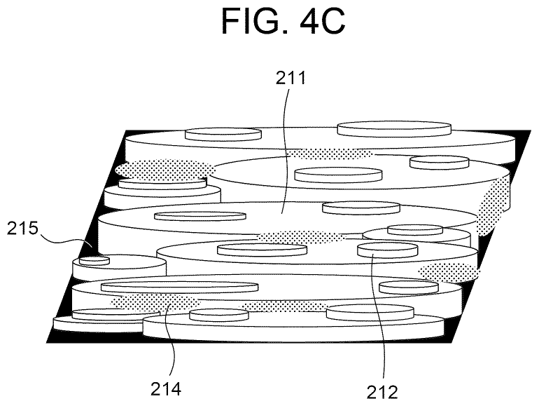

FIG. 4A schematically shows the microstructure of the joint portion 121a.

The joint portion 121a includes a mixture of, for example, crystalline planes (crystal planes) 211 and 212 of Ag (conductive material), glasses 214 (insulators), and voids 215. A large amount of glass 214 is present between the base electrode 121 and the outer surface of the magnetic base body 11, and the strength is obtained at the interface between the base electrode 121 and the outer surface of the magnetic base body 11.

The crystalline planes 211 and 212 of Ag of the joint portion 121a are, for example, the (111) crystalline plane 211 and other crystalline planes 212. “Other crystalline planes” 212 include the (100) crystalline plane and the (110) crystalline plane. The area ratio of the crystalline planes 211 ((111) crystal planes) in the joint portion 121a is smaller than the area ratio of the crystalline planes 212 ((100) crystal planes and the (110) crystal planes). The area ratios of the crystalline planes 211 and 212 may be obtained from the cross-sectional view of 2000 times the joint portion 121a using, for example, the electron-beam backscattering method, or may be obtained from the length ratio.

Similar to the joint portion 121a, the area ratio of the (111) crystalline planes 211 in the first base electrode 121b is smaller than the area ratio of the other crystalline planes 212 ((100) crystalline planes and the (110) crystalline planes). On the other hand, in the second base electrode 121c, the area ratio of the crystalline planes 212 is smaller than the area ratio of the (111) crystalline planes 211.

Here, a structure of the joint portion 121a (base electrode 121) prior to joining and a structure of the joint portion 121a (base electrode 121) after the joining will be described with reference to FIG. 4B and FIG. 4C. FIG. 4B illustrates the structure of the joint portion 121a (base electrode 121) prior to the joining. FIG. 4C illustrates the structure of the joint portion 121a (base electrode 121) after the joining.

The base electrode 121 undergoes a sintering process so that a powder of starting materials (Cu, Ag, Pd) experiences solid-phase sintering. As a result, as shown in FIG. 4B, the base electrode 121 has a stairway structure having contour lines. The (111) crystal lines 211 are parallel to the bottom surface 101 of the base body 11. Other crystal planes 212 are exposed in the form of step surfaces and have different plane orientations than the (111) crystal planes 211.

During the course of the joining process from FIG. 4B to join the end 141 of the conductor 14 to the base electrode 121 (to join the end 141 to the joint portion 121a), the stairway structure (three-dimensional structure) of the base electrode 121 undergoes plastic deformation. As a result of plastic deformation, as shown in FIG. 4C, the (111) crystal planes 211 and the other crystal planes 212 have the same plane orientation. This provides an interface between the joint portion 121a and the end 141.

The base electrode 121 of the external electrode 12 is formed by applying a paste of a metal material containing metal particles to the outer surface of the magnetic base body 11 and sintering the metal material. The metal material may be a combination of metal particles having different shapes or a combination of metal particles having different sizes. In terms of shape, this combination includes, for example, a plate-like shape and/or a scaly shape, together with a spherical shape. In terms of size, this combination includes, for example, a plate-like shape having a large dimension in the longest direction and/or a scaly shape having a large dimension in the longest direction, together with a small spherical shape. Sintering temperature of the joint portion 121a is, for example, between 0.6 times and 0.85 times the metallic melting point of the joint portion 121a when measured in Kelvin temperature.

Sintering of the metal material is performed at a temperature such that the entire metal grains do not sinter, at least in the joint portion 121a, when sintering is finished. For example, the small metal particles in the metal material spread to the surrounding metal particles because of the ease of surface melting, thereby the gap is reduced and densification proceeds whereas the large metal particles hardly melt and sintering is performed at a temperature that hinders densification. In addition, plate-like, scaly and spherical particles may be combined, and some of the particles having a large specific surface area may spread and be incorporated into the surrounding metal particles depending upon the shape of the spreading particle concerned.

In this way, in the joint portion 121a, the densification of metallic material is incomplete or non-uniform. As a result, crystalline planes 212 are more formed than the (111) crystalline planes 211 in this embodiment. As described below, the joining strength at the joining surface between the base electrode 121 and the end 141 of the conductor 14 is enhanced. For example, the filling ratio of the metal material in the base electrode 121 is between 60% and 85%.

Since the metals at the (111) crystalline planes 211 are dense and stable, metal diffusions between the conductors 14 and the joint portion 121a are unlikely to occur at the time of joining. On the other hand, the crystals of the (100) crystalline planes 212 and the (110) crystal planes 212 are not in a stable state so that diffusion is likely to occur, and the (100) crystalline planes 212 and the (110) crystalline planes 212 can receive (accept) the metals that have diffused and moved thereto.

Therefore, the area ratio of the crystalline planes 212, which are not stable as a metal, is larger than the area ratio of the (111) crystalline plane 211, which is stable as a metal. Thus, the diffusion of the metals easily occurs between the joint portion 121a and the conductor 14, and movements of the metals easily occur upon diffusion of the metals. As a result, joining at this interface is strong. For this reason, even when a thick conductive wire is used (e.g., the restriction on the thickness of the conductive wire of the conductor 14 is relaxed and the area of the joining surface is increased), metallic diffusion is likely to occur in the entire joint portion 121a, and the joining strength is enhanced.

Referring back to FIGS. 1 to 3, the conductive resin layer 123 of each of the external electrodes 12 includes a resin and a metal filler. The resin of the conductive resin layer 123 is, for example, a thermosetting resin, and the metal filler of the conductive resin layer 123 includes, for example, a metal having the same component as that of the base electrode 121. Examples of the metallic filler include Ag, Pd, Cu, Al, Ni and Sn, and alloys thereof, and the preferred metallic filler is Ag or Cu.

It should be noted that one kind of the metal filler may be used alone, or two or more kinds of the metal filler may be used in combination. If two or more kinds of the metal filler are used, a shape of a sphere, a long sphere, a flat shape, a rod shape, and the like may be used in combination. In particular, a combination of the rod shape and the sphere shape or a combination of the rod shape, the sphere shape and the flat shape is preferable. For example, the conductive resin layer 123 includes more flat metal fillers than other metal fillers in order to reduce resistance. The conductive resin layer 123 includes a resin (e.g., an epoxy resin, a phenol resin or an acrylic resin). The content of the resin in the conductive resin layer 123 is between 30 vol % and 70 vol %.

The end 141 of the conductor 14 is sandwiched between the conductive resin layer 123 and the joint portion 121a. When the conductive resin layer 123 is provided in the external electrode 12, the conductive resin layer 123 reduces the stress caused by the strain of the substrate 200 or the like. The effect of the stress relaxation by the conductive resin layer 123 extends not only to the junction between the base electrode 121 and the end 141 but also to the lead-out portion of the conductor 14 or the like via the end 141. Therefore, even if the conductor 14 is made of a thin conductive wire, a defect due to stress is suppressed or prevented.

The conductive resin layer 123 covers the outside (lower surface) of the end 141 of the conductor 14. Therefore, the conductive resin layer 123 holds the end 141 of the conductor 14, and suppresses the stress on the end 141 of the conductor 14. As shown in FIG. 3, the conductive resin layer 123 is in contact with the first base electrode 121b. Therefore, the conductive resin layer 123 surrounds the periphery of the end 141 joined to the joint portion 121a.

The conductive resin layer 123 is provided in a wider area than the joint portion 121a and covers the entire base electrode 121. Therefore, the effect of stress relaxation can be obtained regardless of the direction of stress.

The plating layer 124 may be provided on the surface of the external electrode 12 and may cover the entire resin layer 123. The plating layer 124 is made of a metal material having excellent conductivity. For example, Cu or Ag may be used as the metallic material of the plating layer 124. Alternatively, Ni, Pd or Sn may be used as the metallic material of the plating layer 124. The plating layer 124 is formed in a multi-layer structure, e.g., layers mainly composed of the above-mentioned metal material may form a multi-layer structure, or partially alloyed layers may form a multi-layer structure. The plating layer 124 is provided to increase the strength of soldering to the external electrode 12. It should be noted that the plating layer 124 may be replaced with a solder layer because of ease of soldering.

### Modifications

Hereinafter, modifications to the above-described coil component 100 will be described. The following description will focus differences from the above-described coil component 100, and redundant description of elements similar to those described will be omitted.

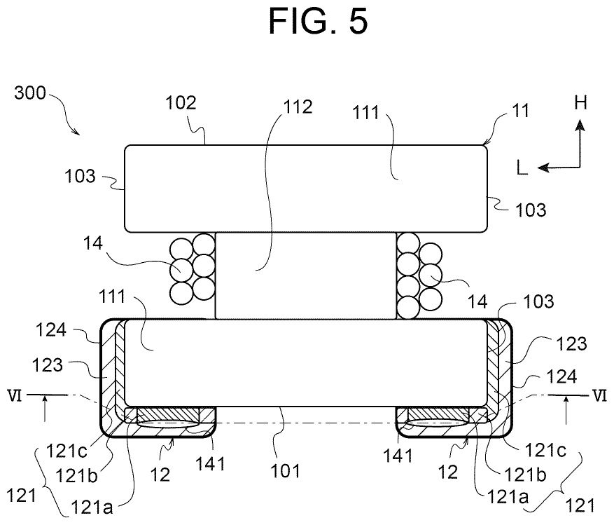

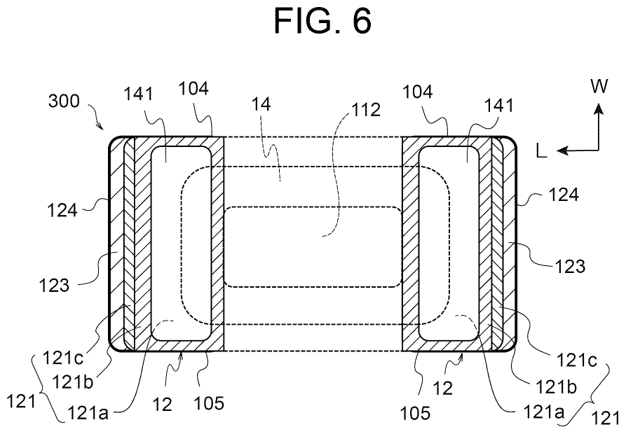

FIG. 5 and FIG. 6 show a first modification (coil component 300) in which the orientation of the drum core is different from FIGS. 2 and 3. FIG. 5 shows a longitudinal cross-sectional view, taken in parallel to the H axis and the L axis. FIG. 6 shows a cross-sectional view taken along the VI-VI line in FIG. 5.

The orientation of the magnetic base body 11 in the coil component 300 of the modification shown in FIGS. 5 and 6 is different from FIGS. 2 and 3. Specifically, one of the flanges 111 is positioned on the bottom surface 101 side which is a mounting surface. The other of the flanges 111 of the magnetic base body 11 is located on a side of the upper surface 102 side. The winding core 112 of the magnetic base body 11 extends in the height direction H, and the conductor 14 has a so-called horizontal winding in which a conductive wire winds generally in parallel to the bottom surface 101 and the top surface 102. The coil component 300 may not include the exterior portion 13 as shown in FIG. 5.

In the modification illustrated in FIGS. 5 and 6, each of the external electrodes 12 includes the base electrode 121, the conductive resin layer 123, and the plating layer 124, and the end 141 of the lead-out portion of the conductor 14 is joined to the joint portion 121a. In the modification illustrated in FIGS. 5 and 6, the wire of the conductor 14 is thick so that the area of the joining surface is large, but the joining strength is high because the external electrode 12 has the joint portion 121a of the above-described crystal-plane structure. In the base electrode 121 of the illustrated modification, the first base electrode 121b is provided around the joint portion 121a, and the second base electrode 121c is separate from the joint portion 121a.

The first base electrode 121b has the same crystal plane structure as the joint portion 121a, and the second base electrode 121c has a crystal plane structure that differs from the joint portion 121a. For example, in the second base electrode 121c, the area ratio of the (111) crystal planes is larger than the area ratio of the “other crystal planes”. Because the external electrode 12 includes base electrode 121 that has the above-described second base electrode 121c, the external electrode 12 can have the required strength and resistivity.

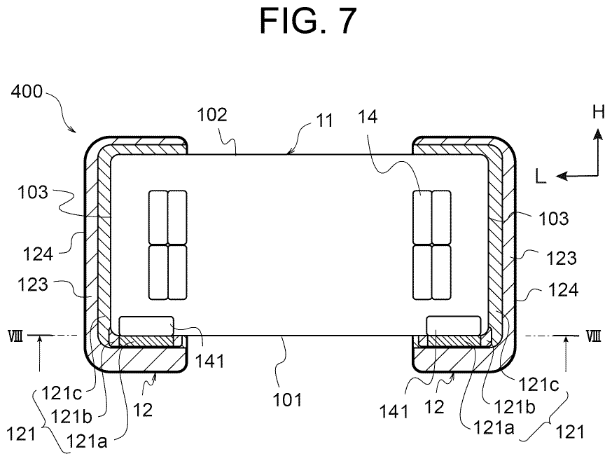

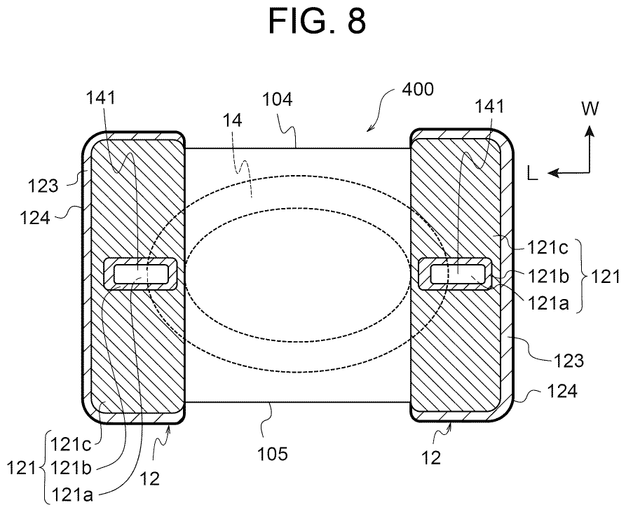

FIG. 7 and FIG. 8 show a second modification (coil component 400). The coil component 400 is a lamination type. FIG. 7 shows a longitudinal cross-sectional view, taken in parallel to the H axis and the L axis. FIG. 8 shows a cross-sectional view along the VIII-VIII line in FIG. 7.

FIG. 7 and FIG. 8 show a laminated-type coil component 400. In the laminated-type coil component 400, the conductor 14 is provided inside the magnetic base body 11, and the end 141 of the lead-out portion is exposed to the bottom surface 101 of the magnetic base body 11.

The coil component 400 illustrated in FIGS. 7 and 8 has two external electrodes 12, each of which is referred to as a five-sided (five face) electrode. The five-sided electrode (external electrode) 12 extends from one side surface 103 to the bottom surface 101, the upper surface 102, the front surface 104, and the rear surface 105.

The external electrode 12 includes a base electrode 121, a conductive resin layer 123, and a plating layer 124, and the base electrode 121 has a first base electrode 121b around the joint portion 121a. In the laminated-type coil component 400, the metal material of the base electrode 121 is applied to a portion where the end 141 of the lead-out portion is exposed, and the applied metal material is sintered. As a consequence, the base electrode 121 is formed and the end 141 is joined to the joint portion 121a.

In the coil component 400 illustrated in FIGS. 7 and 8, the joint portion 121a and the first base electrode 121b are only formed to a region overlapping with the end 141, and the remaining portion of the base electrode 121 is a second base electrode 121c. When the area in which the joint portion 121a and the first base electrode 121b are formed is limited (restricted) and the area of the second base electrode 121c in the base electrode 121 is large, the base electrode 121 as a whole has high strength and low resistivity. When the area in which the second base electrode 121c is provided is not limited to the same surface as the first base electrode 121b, but is provided over two surfaces, higher strength is obtained. That is, the coil component 400 produced in this manner is connected to the conductor 14 by the joint portion 121a, and the strength as an external electrode is obtained by the second base electrode 121c.

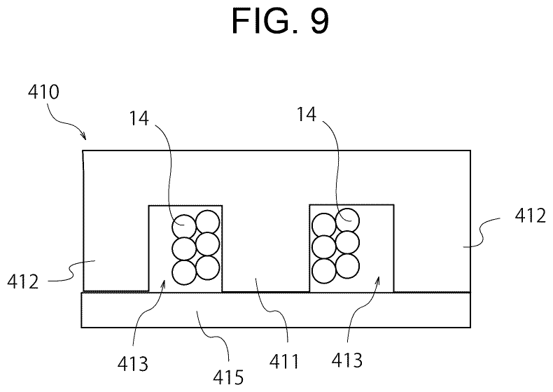

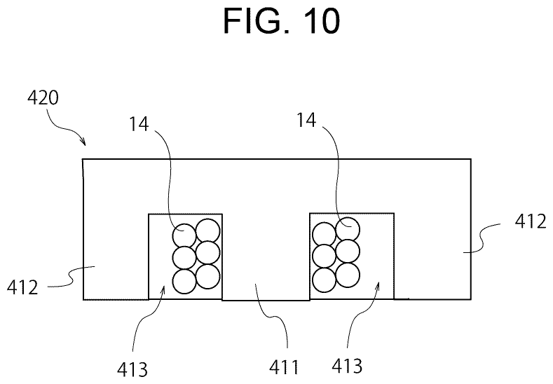

FIG. 9 shows a third modification (base body 410) and FIG. 10 shows a fourth modification (base body 420). In each of the third and fourth modifications, the magnetic base body 410/420 is an E-core type. The magnetic base body 410 is different from the magnetic base body 420.

Each of the magnetic base bodies 410 and 420 shown in FIGS. 9 and 10 may be used instead of the magnetic base body 11 shown in FIGS. 1 to 3, for example. The E-core type magnetic base body 410/420 has a winding core 411 and a peripheral wall 412 surrounding the periphery of the winding core 411. An annular groove 413 that circulates (extends) around the winding core 411 is formed between the winding core 411 and the peripheral wall 412. A conductor 14 that winds around the winding core 411 is provided in the annular groove 413.

In the magnetic base body 410 shown in FIG. 9, the annular groove 413 is closed by a lid 415. The lid 415 is made of a magnetic material. The conductor 14 is received in the magnetic base body 410. On the other hand, the magnetic base body 420 shown in FIG. 10 has no lid. The magnetic base body 420 is used in a state in which the annular groove 413 is opened.

Even when the E-core type magnetic base body 410/420 is used, the base electrode 121 having the above-described crystal plane structure is formed on the outer surface of the magnetic base body 410/420, and the end 141 of the conductor 14 is joined to realize strong joining.

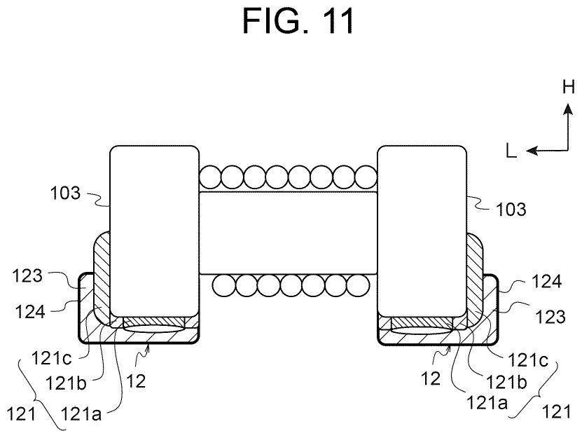

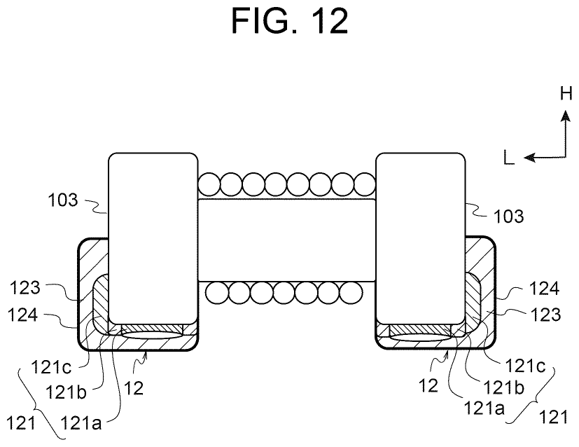

FIG. 11 shows a fifth modification and FIG. 12 shows a sixth modification. The structure of the external electrodes 12 in the fifth/sixth embodiment is different from FIG. 2.

In each of the modifications shown in FIGS. 11 and 12, each of the external electrodes 12 includes a base electrode 121, a conductive resin layer 123, and a plating layer 124. However, in the modification illustrated in FIG. 11, the second base electrode 121c extends more (extends higher) than the conductive resin layer 123 on the side surface 103. The conductive resin layer 123 is thicker than other layers in the external electrode 12. Thus, if the extending area of the conductive resin layer 123 is small, it contributes to the downsizing of the coil component. Since the stress applied to the external electrode 12 is relaxed by the conductive resin layer 123 and is applied inward from the end portion of the base electrode 121, peeling of the external electrode 12 from the magnetic base body 410/420 at the end portion of the base electrode 121 is prevented.

On the other hand, in the modification illustrated in FIG. 12, the conductive resin layer 123 extends more (extends higher) than the second base electrode 121c on the side surface 103. Therefore, the stress generated in the external electrode 12 is relaxed by the conductive resin layer 123. Accordingly, the modification of FIG. 12 is suitable, for example, for a coil component that has thick external electrodes 12 or large-area external electrodes 12.

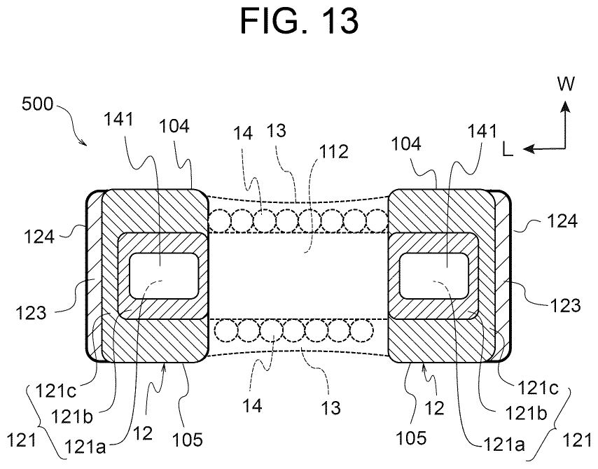

FIG. 13 shows a seventh modification (coil component 500) in which the area of each of the first base electrodes 121b is small.

While the first base electrode 121b of each of the base electrodes 121 shown in FIG. 3 extends over the entire bottom surface 101 of the magnetic base body 11, the first base electrode 121b of the base electrode 121 of the coil component 500 of the modification shown in FIG. 13 extends only around the end 141 of the conductor 14 on the bottom surface 101 of the magnetic base body 11. A second base electrode 121c extends around the first base electrode 121b.

In the modification illustrated in FIG. 13, the two conductive resin layers 123 entirely cover the two base electrodes 121, respectively. Thus, when viewed perpendicular to the bottom surface 101, each of the conductive resin layers 123 surrounds the joint portion 121a and the first base electrode 121b over a half circumference or more on the bottom surface 101. Therefore, the conductive resin layer 123 can disperse the stress applied in any direction, and the joining between the base electrode 121 and the end 141 of the conductor 14 is protected.

It will be apparent to those skilled in the art that various modifications and variations can be made in the present disclosure without departing from the spirit or scope of the disclosure. Thus, it is intended that the present disclosure cover modifications and variations that come within the scope of the appended claims and their equivalents. In particular, it is explicitly contemplated that any part or whole of any two or more of the embodiments and their modifications described above can be combined and regarded within the scope of the present disclosure.

1. A coil component, comprising:
a magnetic base body;
a conductor in the magnetic base body or on a surface of the magnetic base body; and
an external electrode on the surface of the magnetic base body, wherein
the external electrode includes a base electrode that has a joint portion joined to an end of the conductor,
the joint portion extends in a same range as the end of the conductor, and
an area ratio of (111) crystal planes in the joint portion is smaller than an area ratio of other crystal planes in the joint portion.

2. The coil component according to claim 1, wherein the joint portion is between the surface of the magnetic base body and the end of the conductor.

3. The coil component according to claim 1, wherein the base electrode has a first base electrode around the joint portion, and an area ratio of (111) crystal planes in the first base electrode is smaller than an area ratio of other crystal planes in the first base electrode.

4. The coil component according to claim 3, wherein the base electrode has a second base electrode around the first base electrode, and an area ratio of (111) crystal planes in the second base electrode is greater than an area ratio of other crystal planes in the second base electrode.

5. The coil component according to claim 1, wherein the external electrode includes a conductive resin layer outside the joint portion, and the conductive resin layer contains metal particles and a resin.

6. The coil component according to claim 5, wherein the conductive resin layer extends in a range wider than a range of the joint portion.

7. The coil component according to claim 5, wherein the conductive resin layer covers the end of the conductor.

8. The coil component according to claim 1, wherein the external electrode has a plating layer on a surface thereof.
